(19) United States
(12) Patent Application Publication
(10) Pub. No.: US 2023/0228560 A1
(43) Pub. Date: Jul. 20, 2023

(54) DETERMINING A PREFERRED REGION OF A SCANNER

(71) Applicant: Hewlett-Packard Development Company, L.P., Spring, TX (US)

(72) Inventors: Faisal Azhar, Bristol (GB); Guy De Warrenne Bruce Adams, Bristol (GB); Stephen Bernard Pollard, Bristol (GB); Fraser John Dickin, Bristol (GB)

(73) Assignee: Hewlett-Packard Development Company, L.P., Spring, TX (US)

(21) Appl. No.: 17/777,607

(22) PCT Filed: Nov. 19, 2019
(86) PCT No.: PCT/US2019/062191

§ 371 Date: May 17, 2022

(51) Int. Cl. G01B 11/08

(52) U.S. Cl. CPC G01B 11/08; B25J 9/16

(57) ABSTRACT

A method comprising scanning a test artefact at plurality of locations relative to the scanner to create test data. Determining a measured dimension of the test artefact in each of the plurality of locations based on the test data. Determining an error between the measured dimension and an actual dimension of the test artefact in each of the plurality of locations to create error data. Determining from the error data a preferred region relative to the scanner for scanning and adjusting a position of the scanner relative to an object to be scanned so the object is within the preferred region.

Scanning an object surface in three dimensions to create digital data, for example to create a digital model of the object, may be helpful when trying to recreate an existing object, or when trying to validate objects created by additive manufacturing processes.

Various scanners exist that can be used to scan objects. The accuracy of such scanners continues to improve, but errors may still be present in the scan data.

Examples of the present disclosure will now be described with reference to the accompanying Figures, in which:

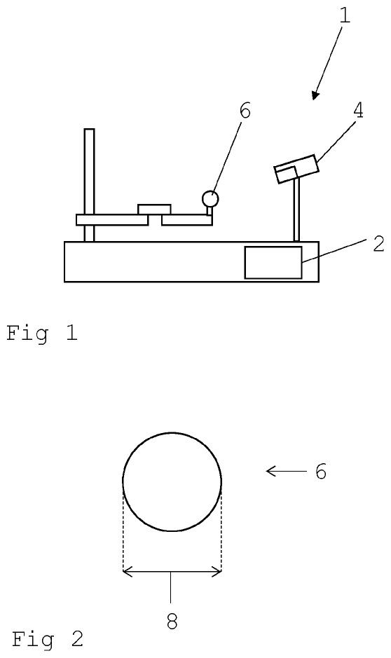

FIG. 1 shows a schematic view of an example of system comprising a controller;

FIG. 2 shows an example of a test artefact;

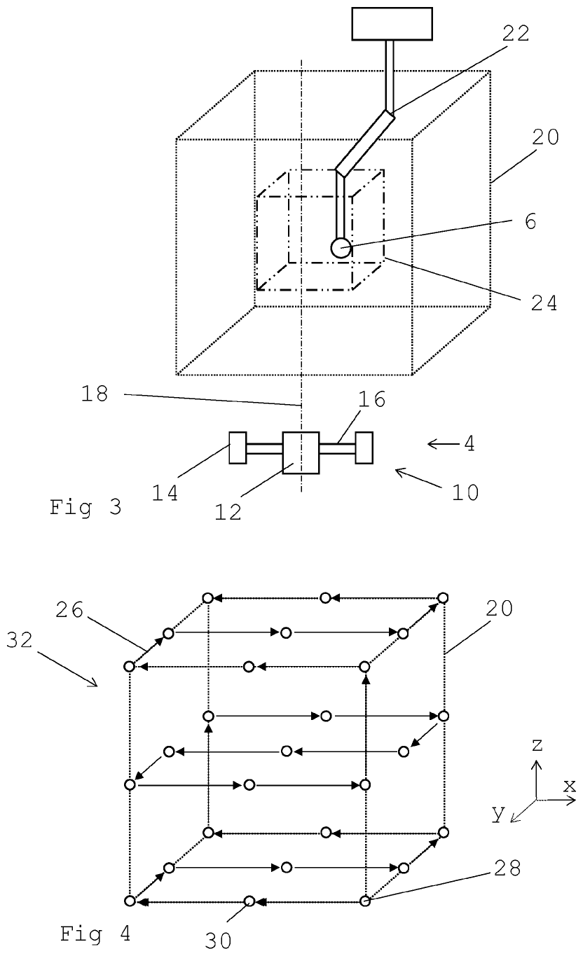

FIG. 3 shows a schematic view of a scanner and a test artefact;

FIG. 4 illustrates an example of a path along which a test artefact may be moved;

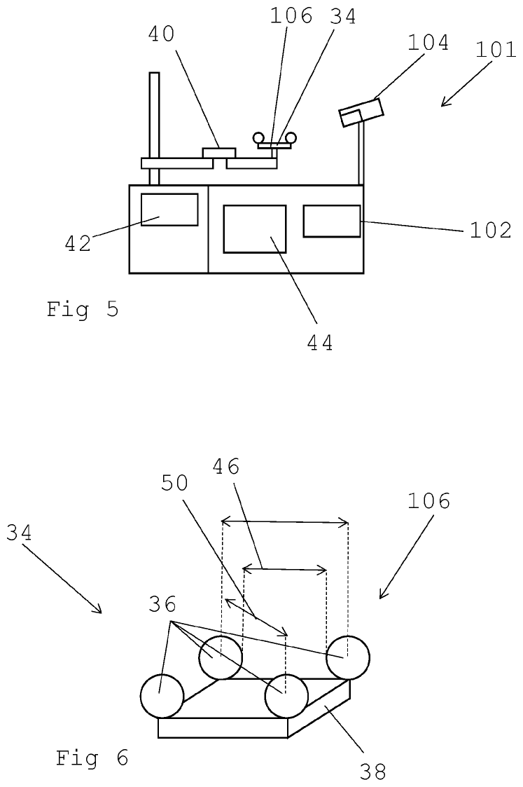

FIG. 5 shows a schematic view of a different example of system comprising a controller;

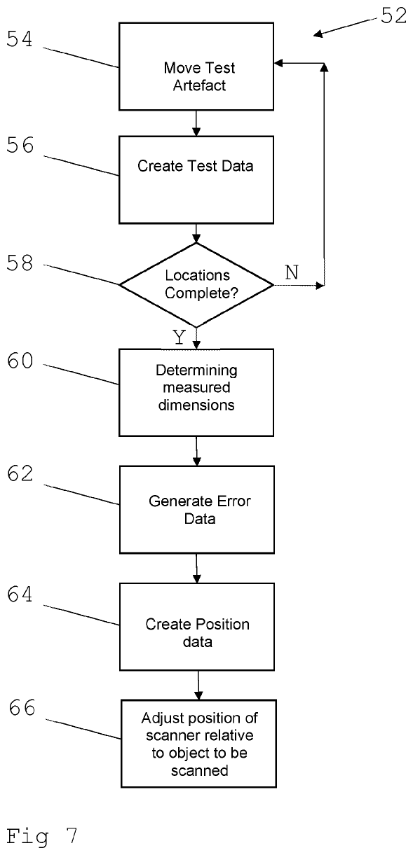

FIG. 6 shows an example of a different test artefact;

FIG. 7 shows a flow chart of an example of a method; and

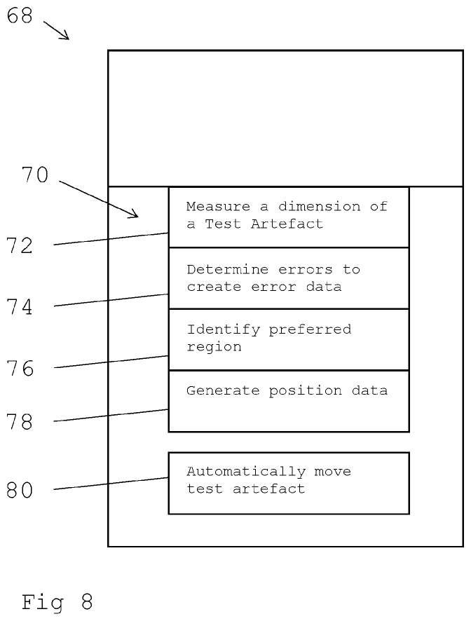

FIG. 8 shows a schematic representation of an example of a controller.

FIG. 1 shows a schematic view of an example of system 1 comprising a controller 2. The controller 2 is able to cause a scanner 4 to scan a test artefact 6 at a plurality of locations relative to the scanner 4 to determine a measured dimension of the test artefact 6 in each of the plurality of locations.

An example of a test artefact 6 suitable for use in the system 1 of FIG. 1 is shown in FIG. 2. The test artefact 6 of this example is a ball which is spherical in shape and which has a known dimension, in this case a diameter, which can be determined by a scanner 2. The actual dimension of the test artefact 6, in this case the diameter 8, is measured, or manufactured, to be a known dimension. The test artefact 6 may be manufactured from a material with a low degree of thermal expansion to avoid temperature variations introducing errors in the actual dimension. An actual dimension of the test artefact 6 could be measured by any suitable device, for example a co-ordinate measuring machine (CMM), callipers, a micrometer, or another gauge. The test artefact 6 may be precision manufactured so that an actual dimension of test artefact 6 is known following manufacture.

In this example system 1 the test artefact 6 is supported by a jointed arm 22 so that the location of the test artefact 6 is such that it can be scanned by the scanner 4 in that location. The jointed arm 22 supports the test artefact 6 and allows the test artefact 6 to be moved to a plurality of different locations in which the test artefact can be scanned by the scanner 4. Although a jointed arm 22 provides a convenient apparatus with which to support a test artefact 6 any suitable object support can be used to support a test artefact 6.

The controller 2 is able to determine, directly or indirectly, for example using another component, such as a processor, an error between the measured dimension and the actual dimension of the test artefact 6 in each of the plurality of locations to create error data.

Although in this example the test artefact 6 is a ball and the measured dimension is the diameter 8, the test artefact 6 could be any shape, and could comprise a plurality of individual test objects, for example a plurality of balls on a support. The test artefact has at least one actual dimension which is known, or can be determined, to an accuracy sufficient to allow an appropriate determination of the error between the measured dimension and the actual dimension. As discussed above, the actual dimension 8 may be known to an accuracy at which the error margin is an order of magnitude smaller than the error margin expected of the scanner 2.

From the error data the controller 6 can cause the identification of a preferred region relative to the scanner 2 for scanning. The preferred region relative to the scanner may be identified based on a variety of factors as set out below, but is based on the error data. The controller 2 can also cause position data indicative of the position of the preferred region relative to the scanner 4 to be created.

FIG. 3 shows a schematic view of a scanner 4 and a test artefact 6. In this example the scanner 4 is a structured light scanner 10, although other types of scanner can be used. The structure light scanner 10 of this example comprises a projector 12 and two sensors 14. In a simplified example, during use of the structured light scanner 10 the projector 12 projects a pattern of light onto the test artefact 6 to produce an illumination pattern on the test artefact 6 that appears distorted from perspectives other than that of the projector 12. In other examples the projector 12 may project a single line of light, lines of light, a plurality of patterns, or may project a non-linear pattern of light.

The structured light scanner 10 includes two sensors 14, in this example digital cameras, positioned on a mount 16 at a known position and orientation relative to the projector 12. The sensors 14 are arranged away from a central axis 18 of the projector so that each sensor 14 can view the test artefact 6 from a perspective other than that of the projector 12. It should be noted that, in other examples, only one sensor 14 may be included, or more than two sensors 14 may be included.

A simplified example of a structured light scanner is described above, but there are a variety of other examples. Structured light scanners may use multiple sensed images of the illuminated object to determine scan position data. There are also scanners which use single sensed images of the illuminated object to determine the scan position data. To generate high resolution three dimensional images of an object a plurality of patterns may be used and/or grey scales and/or a plurality of colours may be used. In some scanners a plurality of phase shifted sine wave patterns are projected onto an object and the resulting distorted illumination patterns analysed to determine the scan position data. These are only some examples of structured light scanners and techniques. The system 1 may include any suitable structured light scanner and the scanner could make use of any suitable technique, or a combination of techniques.

FIG. 3 also provides an indication of a scan volume 20 within which the scanner 4 is intended to operate. The scan volume 20 may be a user selected volume within which the scanner 4 can scan an object, for example a test artefact 106. The scan volume 20 may be a volume within which the scanner 4 is calibrated for operation, for example the scan volume may be determined by the manufacturer of the scanner 4.

The test artefact 6 is supported on a jointed arm 22 which allows the test artefact 6 to be translated in three dimensions, for example along x-, y- and z-axes. In this example the jointed arm 22 is manually movable so that a user can manually position the test artefact 6 in a plurality of different locations relative to the scanner 4. In other examples the test artefact 6 may be supported by any suitable support. In some examples the jointed arm 22 may allow the test artefact 6 to be rotated about any of the three dimensions, for example about the x-, y- and z-axes, so that its orientation relative to the scanner can be changed.

In some examples the test artefact 6 may be supported on a platform that is movable in the z-axis and which carries a two-axis support which carries the test artefact 6 and is able to move that object in the x- and y-axis and/or, in some examples, rotate about the x-, y- and z-axes, thus allowing the test artefact 6 to be moved in all axes and/or orientated relative to the scanner. Other object supports allowing an object to be moved to a plurality of locations, either automatically, manually, or otherwise can be used. An object support such as the arm 22 holds the object in each of a plurality of locations while the test artefact 6 is scanned.

Once the test artefact 6 has been moved to a plurality of different locations within the volume 20 and has been scanned in each location, the scans of the test artefact 6 can be processed to determine a measured dimension of the test artefact 6. The measured dimension of the test artefact 6 corresponds to the actual dimension of the test artefact. In this example the measured dimension of the test artefact 6 is the diameter 8 and the actual diameter of the test artefact 6 has been determined by a CMM and has been provided to the system 1, but the actual dimension could be manually input into the system 1.

The error data is indicative of the error between the measured dimension and the actual dimension of the test artefact 6 in each of the plurality of locations. The error data can be processed to identify a preferred region 24 of the volume 20. The preferred region 24 is a sub-region of the volume 20 and is selected based on the error data.

The preferred region 24 may be selected such that the anticipated scan errors in the preferred region are below a threshold. The threshold may be user defined depending upon the accuracy required for a future object scan operation, or may be a predefined threshold. There may be more than one predefined threshold from which a user can select. In this way the preferred region 24 can be selected based upon an error threshold.

In another example, a user may specify a size for a preferred volume, for example based upon the size of an object to be scanned in a future operation. The preferred region may therefore be identified so that the errors within the specified size are minimised. In this way the preferred region 24 can be selected based upon a size of the preferred region 24.

The preferred region 24 may be identified as a cuboid volume as shown in FIG. 3, or could be identified as a range of working distances from the scanner 4.

As noted above, once a preferred region 24 is identified, the controller also causes position data indicative of the position of the preferred region 24 relative to the scanner 4 to be generated. This position data can be used to adjust the position of the scanner 4 and/or an object to be scanned relative to the scanner 4 so that the object to be scanned is located within the preferred region 24.

The adjustment of the position of the scanner 4 and/or an object to be scanned may be manual, with a user guided by a user interface to make appropriate adjustments. The user interface may be any suitable interface for guiding the user, for example a graphical user interface comprising text and/or graphics, which may be displayed on a screen or using guide lights, or the interface may be an audio interface with audio instructions or audible tones guiding the user to move the scanner 4 and/or an object to be scanned.

The adjustment of the position of the scanner 4 and/or an object to be scanned may be at least partly automatic, for example the scanner 4 may be automatically height adjustable so that a base of the preferred region 24 is located on, or below, an object support, for example a turntable. In this way the user has only to position the object support in the correct position relative to the scanner to ensure that the object to be scanned is located within the preferred region.

FIG. 4 shows an example of a path 24 along which a test artefact 6 may be moved in the system 1. The test artefact 6 may start in a first corner 28 of the volume 20. The test artefact 6 is scanned at the start location 28 and then moved half way along the bottom front edge of the volume 20 to the second location 30 where the test artefact 6 is again scanned. The process of moving the test artefact 6 to each of a plurality of locations 32 and scanning the test artefact 6 in each location continues as the object is moved along the path 24. In this example a 3×3×3 grid of locations 32 is created as this is an efficient way in which to move the object through the volume 20, each movement being a distance that is half the length of a side of the volume 20 either in the x, y, or z direction. This regular spacing and grid pattern may facilitate processing of the data generated.

In other examples a 4×4×4 grid of locations 32 may be used. Increasing the number of locations in the plurality of locations may increase the accuracy with which a preferred region can be identified.

In other examples an irregular distribution of locations 32 might be used. Locations 32 may be distributed randomly, or may be concentrated in a particular region of the volume 20 that may be of particular interest.

FIG. 5 shows a schematic view of a different example of system 101 comprising a controller 102 and FIG. 6 shows an example of a different test artefact 106. Like components will be referenced with the same numerals incremented by 100.

Operation of the system 101 is similar to the system 1 described above. The system 101 comprises a controller 102 and a scanner 104 which is able to scan a test artefact 106. In this example the test artefact 106 is a complex artefact 34 best shown in FIG. 6 comprising four balls 36 at the corners of a plate 38.

The system 101 also comprises a robot arm 40 which supports the test artefact 106 and is able to move the test artefact 106 to a plurality of locations relative to the scanner 102. The robot arm 40 is controlled by an arm controller 42 and, in this example the arm controller 42 is controlled by the controller 102 to move the test artefact 106 to the plurality of different locations.

As described above, the test artefact 106 is moved to a plurality of locations and is scanned in each location by the scanner 104. A measured dimension of the test artefact 106 is determined for each location from the scans and error data is determined based on an error between the measured dimension and an actual dimension of the test artefact in each of the plurality of locations. In this example the test artefact 106 is a complex artefact 34 so a plurality of dimensions of the test artefact 106 can potentially be measured and compared to actual dimensions, for example a minimum distance 46 between adjacent balls 36, a separation of the adjacent ball centres 48, or the separation of diagonal ball centres 50. With such a complex test artefact 106 the orientation of the test artefact 106 relative to the scanner 102 may also be controlled and/or adjusted in each location. There are a plurality of other dimensions that could be measured by a scanner and compared with an actual dimension. It should be understood that the diameter of one the balls 36 can be measured and compared to the actual dimension as set out earlier.

Measuring a plurality of dimensions of a test artefact 106 in each position and comparing them with the corresponding actual dimensions may allow the creation of more comprehensive error data for a given plurality of locations.

The system 101 also comprises a user interface 44, in this example in the form of a screen and the controller 102 is able to cause the user interface 44 to provide a visual indication of the preferred region 24 to a user. The visual indication could be a graphic indicating how to move the scanner and/or object to arrange the object within the preferred region 24. The user interface 44 may be any suitable form of interface via which the system 101 can provide information to a user. The interface may comprise, for example, a light, a speaker for producing sounds or a movable mechanical element.

FIG. 7 shows a flow chart 52 of an example of a method. The method begins with moving 54 the test artefact to a location relative to a scanner and generating 56 test data using the scanner. The movement of the test artefact may be manual, or may be automated.

A check 58 is then made to determine whether the test artefact has been moved to all of the locations relative to the scanner and, if not the method returns to the first step 54 and moves the object to a new location and the test data generated 56 again for the new location.

Once the test artefact has been moved to all of the locations intended the test data is automatically processed 60 to determining a measured dimension of the test artefact in each of the plurality of locations based on the test data.

From the measured dimensions in each location an error between the measured dimension and an actual dimension of the test artefact in each of the plurality of locations can be determined 62 to create error data.

The actual dimension, or dimensions, of the test artefact may be preset, or selected from a number of pre-sets, for example if a controller is intended for use with known, predetermined, test artefacts. The actual dimension could be measured by a user and input into the system as part of the method. The actual dimension could be input into the system before, during, or after the scanning of the object in the plurality of locations has occurred.

From the error data a preferred region relative to the scanner is identified 64 and the position of the scanner relative to an object to be scanned is adjusted 66 so the object to be scanned is within the preferred region.

As set out above, the adjustment may be automatic, partly automatic or manual and may be guided by a user interface.

An example using a structured light scanner with stereo cameras will now be described. The baseline distance between the cameras was set at 200 mm. The scanner was calibrated with a nominal working distance of 470 mm to create a scan volume within which the scanner is considered to be calibrated.

A ball, or sphere, of about 25 mm diameter and coloured steel grey was used as a test artefact. The ball was measured by a CMM to determine its actual diameter. The ball was moved within the scan volume of the scanner. A 4×4×4 grid of locations was selected with a 40 mm gap between adjacent locations.

A six degree of freedom robot arm was used to move the ball to each location in a programmatically defined manner and it each position the scanner was triggered to perform a single scan. In each location the diameter of the ball was measured based on the scan data. The deviation between the measured dimension and the actual dimension was calculated for each location.

The measurement errors of the scanner were found to vary from 40 μm to under 20 μm within the tested scan volume of the scanner. In this case it was calculated that diameter size error was smaller for locations at a working distance between 370 mm and 470 mm from the scanner and this was defined as the preferred region.

The scanner was moved 50 mm closer to the object support so that the nominal working distance from the scanner was 420 mm and the ball could be moved 50 mm towards or away from the scanner and remain within the preferred volume.

To test the result the ball was then scanned in a grid of 5×5×5 positions with a 25 mm gap between adjacent locations. The measurement error of the scanner was found to be consistently below 20 μm in the preferred region of the scanner which indicated that a preferred region with an error threshold of 20 μm had been identified.

The method could operate in a sequential manner, with few initial measurements made to identify a first region and the first region could then be investigated in more detail, for example with a greater number of measurements, to identify the preferred region.

FIG. 8 shows a schematic representation of an example of a controller 102. In this example the controller 102 comprises a non-transitory computer-readable storage medium 68 comprising instructions 70 executable by a processor. The machine-readable storage medium 68 comprising:

Instructions 72 to measure a dimension of a test artefact which has been scanned in each of a plurality of locations relative to the scanner.

Instructions 74 to determine an error between the measured dimension and an actual dimension of the test artefact in each of the plurality of locations to create error data.

Instructions 76 to determine from the error data a preferred region relative to the scanner for scanning.

Instructions 78 to generate position data indicative of the position of the preferred region relative to the scanner.

The non-transitory machine-readable storage medium 68 may comprise instructions 80 to use a robot of the scanning system to automatically move the test artefact to each of the plurality of locations.

The non-transitory computer-readable storage medium 68 may further comprise instructions to carry out any of the actions described above, either directly under the control of the controller 216 or through another controller.

1. A method comprising:
scanning a test artefact at a plurality of locations relative to the scanner to create test data;
determining a measured dimension of the test artefact in each of the plurality of locations based on the test data;
determining an error between the measured dimension and an actual dimension of the test artefact in each of the plurality of locations to create error data;
determining from the error data a preferred region relative to the scanner for scanning; and
adjusting a position of the scanner relative to an object to be scanned so the object is within the preferred region.

2. The method of claim 1, in which the method includes automatically moving the test artefact to each of the plurality of locations relative to the scanner.

3. The method of claim 1, in which the method includes providing a visual indication of the preferred region to a user.

4. The method of claim 1, in which the preferred region is defined based upon the scanner having an accuracy greater than a threshold accuracy level within the preferred region.

5. The method of claim 1, in which the preferred region is defined based upon an object volume and the errors within the object volume minimised.

6. The method of claim 1, in which the position of the scanner relative to an object to be scanned is automatically adjusted so that the object is within the preferred region.

7. A system comprising a controller, the controller causing a scanner to scan a test artefact at a plurality of locations relative to the scanner to determine a measured dimension of the test artefact in each of the plurality of locations, the controller causing an error between the measured dimension and an actual dimension of the test artefact in each of the plurality of locations to be determined to create error data and from the error data a preferred region relative to the scanner for scanning to be identified, the controller also causing position data indicative of the position of the preferred region relative to the scanner to be generated.

8. The system of claim 7, in which the test artefact comprises at least one ball, the ball having a known actual dimension.

9. The system of claim 8, in which the test artefact comprises a plurality of balls, each ball having known actual dimensions and the balls being spaced by known distances.

10. The system of claim 7, in which the system further comprises an object support, the position of which can be adjusted relative to the scanner and the controller can cause the position of the object support to be altered based upon the position data so that an object on the support is within the preferred region.

11. The system of claim 7, in which the system further comprises the scanner which is controlled by the controller to scan the test artefact, the scanner being a structured light scanner.

12. The system of claim 7, in which the system includes a robot which can be controlled by the controller to move the test artefact to the plurality of locations relative to the scanner.

13. The system of claim 7, in which the system includes a user interface which can provide a visual indication of the preferred region to a user.

14. A non-transitory machine-readable storage medium comprising instructions executable by a processor, machine-readable storage medium comprising:
instructions to measure a dimension of a test artefact which has been scanned in each of a plurality of locations relative to the scanner;
instructions to determine an error between the measured dimension and an actual dimension of the test artefact in each of the plurality of locations to create error data;
instructions to determine from the error data a preferred region relative to the scanner for scanning; and
instructions to generate position data indicative of the position of the preferred region relative to the scanner.

15. The non-transitory machine-readable storage medium of claim 14, in which the machine-readable storage medium comprises instructions to use a robot of the scanning system to automatically move the test artefact to each of the plurality of locations.
